(19) United States
(12) Patent Application Publication
(10) Pub. No.: US 2010/0174839 A1
(43) Pub. Date: Jul. 8, 2010

(54) MAIN BOARD SYSTEM AND METHOD FOR SETTING MAIN BOARD SYSTEM

(75) Inventor: Ya-Lun HSU, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, Taipei City (TW)

(21) Appl. No.: 12/395,716

(22) Filed: Mar. 2, 2009

(30) Foreign Application Priority Data
Jan. 6, 2009 (TW) 98100191

(51) Int. Cl. G06F 13/00

(52) U.S. Cl. 710/110; 710/104

(57) ABSTRACT

A method for setting a main board system is disclosed. According to the method, a first pin setting signal is received, and a board module is determined if it is a master module or a slave module according to the received first pin setting signal. Then, a potential of a third pin is detected when the board module is the slave module, and the master module is determined whether it exists according to the detected potential of the third pin. After that, the slave module enters a first mode if the master module doesn't exist, and the slave module enters a second mode if the master module exists.

### RELATED APPLICATIONS

This application claims priority to Taiwan Application Serial Number 98100191, filed Jan. 6, 2009, which is herein incorporated by reference.

### BACKGROUND

1. Field of Invention

The present invention relates to an input/output device. More particularly, the present invention relates to an input/output device of a computer system.

2. Description of Related Art

Of different computing systems, such as pc cluster systems, Symmetric Multi-Processing System (SMP system), storage server and network equipment., etc., rack or body having main board or mother board installed therein are typical.

For example, the cluster system, acting as a master node, may include a main board as the major node, or may include a main board as the computing nodes. Each computing node has a dedicated regional baseboard management controller to monitor and control the implementation and the plural operational status of its components. These operation status include the temperature, the voltage, the fan speed, the system hardware security, the power supply working status, and the bus error status.

However, such main board system usually has only one input/output module. If the only one input/output module is damaged, the entire main board system is unable to transfer data, and the main board system can't work as a result. Therefore, there is a need for a new main board system which can maintain the normal operation even if the input/output module of the main board system is damaged.

### SUMMARY

According to one embodiment of the present invention, a method for 1o setting a main board system is disclosed. The method receives a first pin setting signal and, determines whether a board module is a master module or a slave module according to the received first pin setting signal. The method also detects a potential of a third pin when the board module is the slave module, and determines whether the master module exists according to the detected potential of the third pin. Then the method makes the slave module enter a first mode when the master module doesn't exist, or makes the slave module enter a second mode when the master module exists.

According to another embodiment of the present invention, a method for setting a main board system is disclosed. The method receives a first pin setting signal, and determines whether a board module is a master module or a slave module according to the received first pin setting signal. The method also detects a potential of a second pin when the board module is the master module, and determines whether the slave module exists according to the detected potential of the second pin. Then, the method determines whether the master module is in a second mode when the slave module exists, tests whether the slave module is disabled when the master module is in the second mode, and makes the master module change to a first mode when the slave module is disabled.

According to still another embodiment of the present invention, a main board system includes a backplane, a first main board, a second main board, and a host bus adapter. The backplane is electrically connected to at least one hard disk. The first main board includes a master module for transmitting data. The second main board includes a slave module, in which the slave module transmits the data when the master module is disabled or in a second mode. The host bus adapter accesses the data stored in the hard disc through the master module or the slave module.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the block diagram of the main board system according to one embodiment of the present invention;

FIG. 2 shows the flow chart of the method for setting the main board system according to one embodiment of the present invention; and

FIG. 3A shows the part flow chart of the method for setting the main board system according to another embodiment of the present invention;

FIG. 3B shows the another part flow chart of the method for setting the main board system according to another embodiment of the present invention; and

FIG. 3C shows the other part flow chart of the method for setting the main board system according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following embodiment, the main board system and the method for setting the main board system set the master module / slave module of the main board system automatically, and start the master module or the slave module to transmit data. The main board system and the method for setting the main board system start the slave module to transmit data if the master module is disabled, which keeps the main board system operating normally.

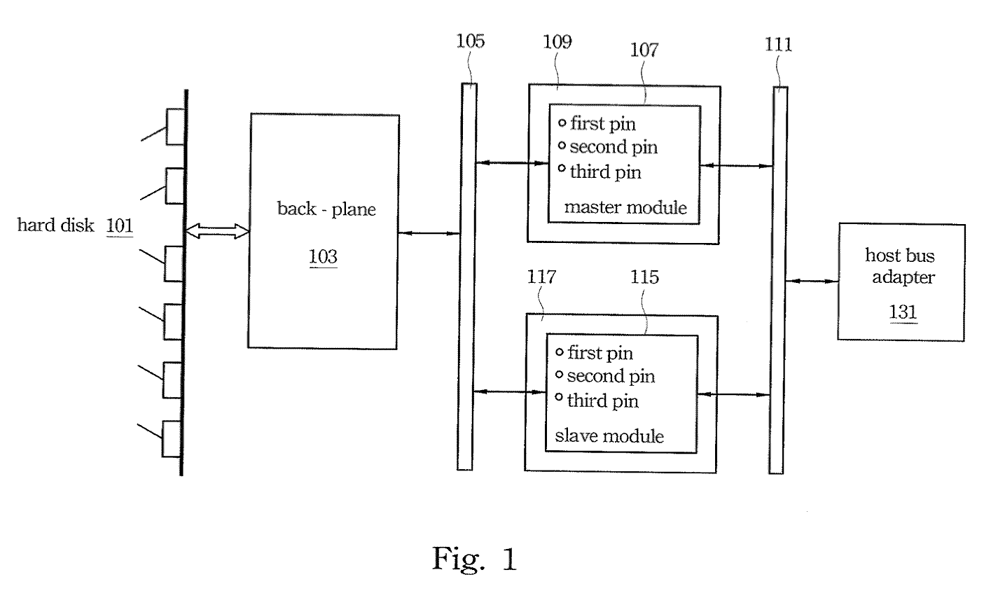

FIG. 1 shows the block diagram of the main board system according to one embodiment of the present invention. The main board system includes the backplane 103, the first main board 109, the second main board 117, and the host bus adapter 131. The backplane 103 is electrically connected to at least one hard disk 101. The first main board 109 includes a master module 107 for transmitting data, and the second main board 117 includes a slave module 115, in which the second pins and the third pins of the mater module 107 and slave module 115 can interconnect with each other directly, or interconnect with each other through the first bus 105 and the backplane 103. The host bus adapter 131 accesses the data stored in the hard disc through the master module or the slave module.

For example, the host bus adapter 131 can drive the second bus 111 to pass the read instructions or the write instructions to the master module 107 or the slave module 115, and the master module 107 or the slave module 115 drives the first bus 105 to pass the instructions to the backplane 103. Then the backplane 103 execute the instructions to read the data from the hard disk 101, or to write the data into the hard disk 101.

In this embodiment, the mater module can be General Purpose Input/Output (GPIO) master modules, and the slave module can be General Purpose Input/Output (GPIO) slave module. The master module 107 or the slave module 115 can operate in the first mode, such as the active mode, for transmitting data. The master module 107 or the slave module 115 can also operate in the second mode, such as the standby mode, to stop transmitting data, in which the slave module operates in the first mode for transmitting data only when the master module is disabled or in the second mode.

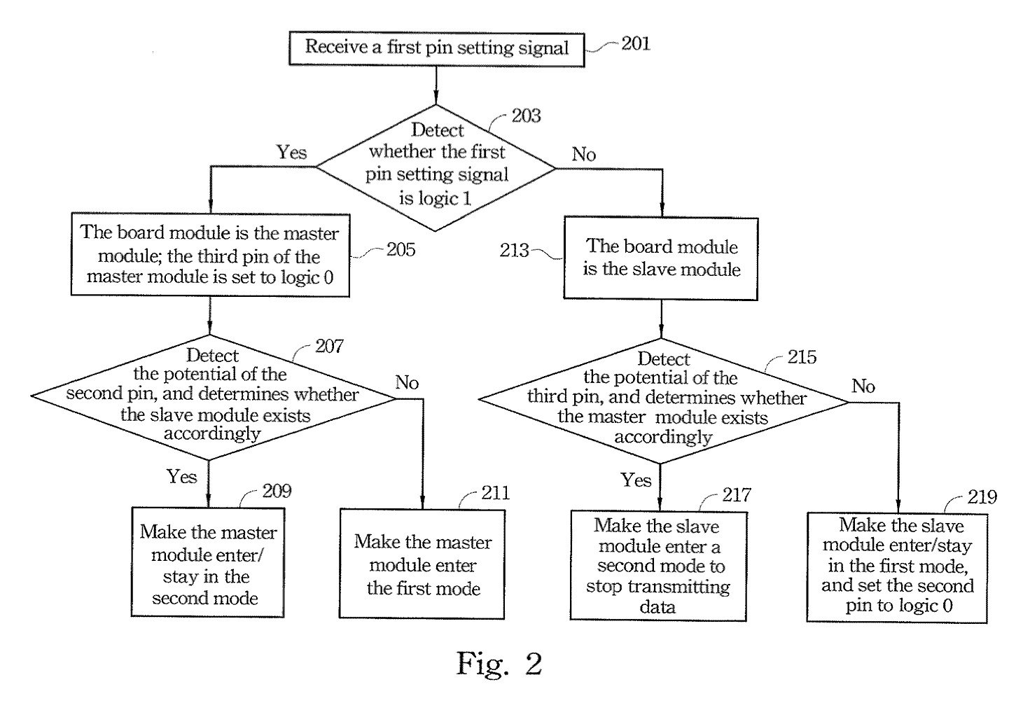

FIG. 2 shows the flow chart of the method for setting the main board system according to one embodiment of the present invention. The method receives a first pin setting signal (step 201), and determines whether a board module is a master module or a slave module according to the received first pin setting signal. In detail, the method can detect whether the first pin setting signal is logic 1 for the determining (step 203). If the first pin setting signal is logic 1, the board module is the master module, and the third pin of the master module is set to logic 0 (step 205); else, if the first pin setting signal is logic 0, the board module is the slave module (step 213).

In step 203, if it is determined that the board module is the slave module, the method detects the potential of the third pin of the slave module, and determines whether the master module exists according to the detected potential of the third pin (step 215). If the master module doesn't exist, the method makes the slave module enter/stay in a first mode for transmitting data, and sets the second pin to logic 0 (step 219); else, the method makes the slave module enter a second mode to stop transmitting data if the master module exists (step 217). That is, the salve module can replace the master module to transmit data when the master module does not exist or is disabled.

On the other hand, if the board module is found to be the master module in step 203, the third pin of the master module is set to logic 0 (step 205). Then the method detects the potential of the master module's second pin when the board module is the master module, and determines whether the slave module exists according to the detected potential of the second pin (step 207). In detail, if the detected potential of the second pin is logic 1, it presents that the slave module doesn't exist, and the method makes the master module enter the first mode (step 211); else, if the detected potential of the second pin is logic 0, it presents that the slave module exists, and the method makes the master module enter/stay in the second mode (step 209).

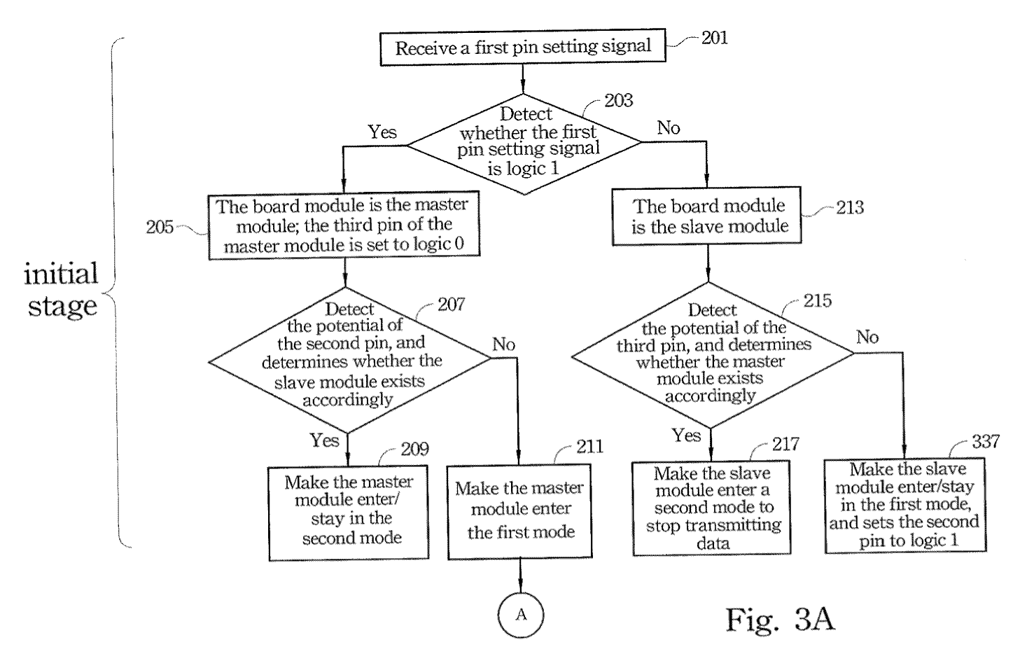

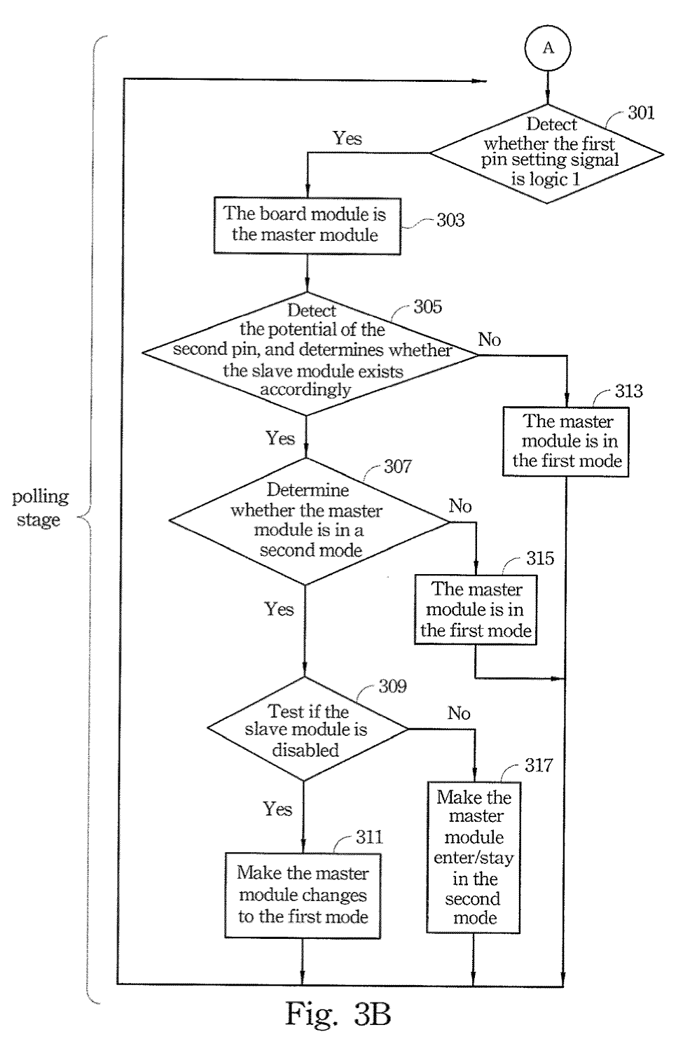

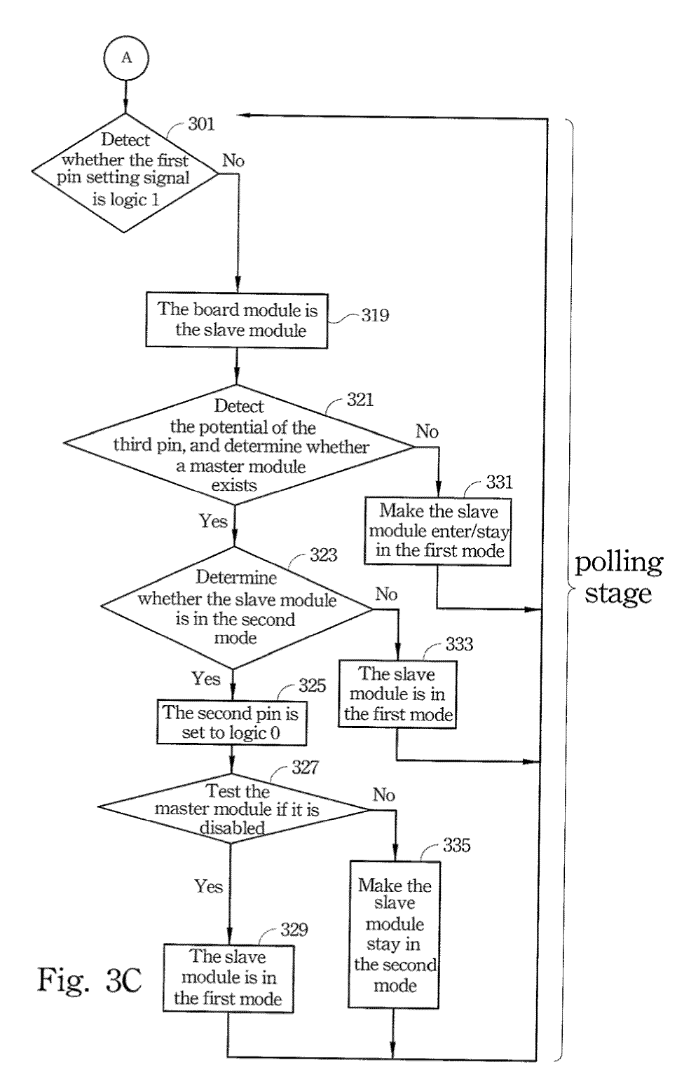

FIG. 3A. FIG. 3B and FIG. 3C shows the flow chart of the method for setting the main board system according to another embodiment of the present invention. The method of this embodiment includes an initial stage and a polling stage. In the initial stage, steps (201-217) in FIG. 3A are same to those steps having the identical labels shown in FIG. 2, except step 337. In step 337, the slave module is in the first mode for transmitting data, and the second pin of the slave module is set to logic 1, such that the master module considers the slave module does not exist, and the master module enters the first mode to transmit data as a result.

After the initial stage, the polling stage is executed (FIG. 3B. FIG. 3C). In the beginning of the polling stage, the method for setting the main board system determines whether the board module is a master module or a slave module lo again according to the received first pin setting signal. In detail, the method for setting the main board system detects whether the first pin setting signal is logic 1 (step 301). If the first pin setting signal is logic 1, the board module is the master module (step 303). Next, the method detects a potential of a second pin when the board module is the master module, and determines whether the slave module exists according to the detected potential of the second pin (step 305). Specifically, if the potential of the second pin is logic 0, the slave module exists, then the method further determines whether the master module is in a second mode (step 307). If the master module is in the second mode, the method continues to test if the slave module is disabled (step 309). If the slave module is not disabled, then the method makes the master module enter/stay in the second mode (step 317); else, if the slave module is disabled, then the method makes the master module changes to the first mode (step 311).

In addition, if step 305 finds out that the slave module does not exist, or step 307 finds that the master module is not in the second mode, then the master module is in the first mode (step 313, step 315).

On the other hand, if the board module is the slave module (step 319), the method detects the potential of the third pin of the slave module, and determines whether a master module exists according to the detected potential of the third pin (step 321). Specifically, if the potential of the third pin is logic 1, which means the master module doesn't exist, then the method makes the slave module enter the first mode (step 331); else, if the potential of the third pin is logic 0, which means the master module exists, then the method continues to determine whether the slave module is in the second mode (step 323). If the slave module is in the second mode, the second pin of the slave module is set lo to logic 0 (step 325), and the master module is tested if it is disabled (step 327). If the mater module isn't disabled, then the method makes the slave module stay in the second mode (step 335); else, if it is determined that the master module is disabled in step 327, then or it is determined that the slave module isn't in the second mode in step 323, then the slave module is in the first mode (step 329, step 333).

According to one of the above embodiments, the main board system and the method for setting the main board system set the board module as the master module or the slave module automatically; according to one of the above embodiments, the method makes only the mater module or the slave module enter the first mode (active mode) to transmit data. Because only one module transmits the data, the modules don't scramble for the bus, and the bus arbitration is not required. In addition, the slave module can replace the master module for transmitting the data if the master module is disabled, thus the main board system can still operate correctly even if the master module is damaged.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for setting a main board system, comprising:
receiving a first pin setting signal;
determining whether a board module is a master module or a slave module according to the received first pin setting signal;
detecting a potential of a third pin when the board module is the slave module;
determining whether the master module exists according to the detected lo potential of the third pin;
making the slave module enter a first mode when the master module doesn't exist; and
making the slave module enter a second mode when the master module exists.

2. The method for setting the main board system as claimed in claim 1, further comprising:
detecting the potential of a second pin when the board module is the master module;
determining whether the slave module exists according to the detected potential of the second pin;
making the master module enter the first mode when the slave module doesn't exist; and
making the master module enter the second mode when the slave module exists.

3. The method for setting the main board system as claimed in claim 2, further comprising setting the third pin of the master module to logic 0 when the board module is the master module.

4. The method for setting the main board system as claimed in claim 1, further comprising setting the second pin of the slave module to logic 0 when the master module doesn't exist.

5. The method for setting the main board system as claimed in claim 1, wherein the first mode transmits system data, and the second mode doesn't transmit the system data.

6. The method for setting the main board system as claimed in claim 1, wherein the mater module and the slave module are General Purpose Input/Output modules.

7. A method for setting a main board system, comprising:
receiving a first pin setting signal;
determining whether a board module is a master module or a slave module according to the received first pin setting signal;
detecting a potential of a second pin when the board module is the master module;
determining whether the slave module exists according to the detected potential of the second pin;
determining whether the master module is in a second mode when the slave module exists;
testing whether the slave module is disabled when the master module is in the second mode; and
making the master module change to a first mode when the slave module is disabled.

8. The method for setting the main board system as claimed in claim 7, further comprising making the master module stay in the second mode when the slave module is not disabled.

9. The method for setting the main board system as claimed in claim 7, further comprising making the master module enter the first mode when the slave module doesn't exist.

10. The method for setting the main board system as claimed in claim 7, further comprising:
detecting the potential of a third pin when the board module is the slave module;
determining whether a master module exists according to the detected potential of the third pin; and
making the slave module enter the first mode when the master module doesn't exist.

11. A main board system, comprising:
a backplane electrically connected to at least one hard disk;
a first main board including a master module for transmitting data;
a second main board including a slave module, wherein the slave module transmits the data when the master module is disabled or in a second mode; and
a host bus adapter accessing the data stored in the hard disc through the master module or the slave module.

12. The main board system as claimed in claim 11, wherein the mater module and the slave module are General Purpose Input/Output modules.
